(19) United States
(12) Patent Application Publication
(10) Pub. No.: US 2022/0097183 A1
(43) Pub. Date: Mar. 31, 2022

(54) PROCESSING MACHINE AND PROCESSING METHOD

(71) Applicant: HONDA MOTOR CO., LTD., Minato-ku, Tokyo (JP)

(72) Inventors: Kazunao Uchiyama, Guangzhou (CN); Akio Fujisaki, Guangzhou (CN)

(21) Appl. No.: 17/426,131

(22) PCT Filed: Oct. 3, 2019
(86) PCT No.: PCT/JP2019/039046

§ 371 Date: Jul. 28, 2021

(30) Foreign Application Priority Data
Feb. 1, 2019 (CN) 201910105643.5

(51) Int. Cl. B23K 37/04

(52) U.S. Cl. CPC B23K 37/04

(57) ABSTRACT

A processing machine is provided with: at least one dolly on which a workpiece (vehicle body floor) is placed; and a robot that is placed on the dolly and performs a predetermined process (re-spot welding) using a processing tool (welding gun), on the workpiece while the dolly is moving.

### TECHNICAL FIELD

The present invention relates to a processing machine and a processing method for performing prescribed processing on a workpiece using a processing tool.

### BACKGROUND ART

JP 2003-145276 A discloses a vehicle body welding system that, in a state where a vehicle body (workpiece) is arranged on a line, performs respot welding (predetermined processing) from the left and right on each part of the vehicle body.

### SUMMARY OF INVENTION

The vehicle body welding system disclosed in JP 2003-145276 A sequentially moves the vehicle body through welding work regions on the line, and performs the respot welding on different portions of the vehicle body between the welding work regions. With this vehicle body welding system, respot welding cannot be performed while the vehicle body is being moved between the welding work regions, and therefore the processing productivity cannot be improved.

The present invention has been devised in order to solve this type of problem, and has the object of providing a processing machine and processing method that can improve the processing productivity.

A first aspect of the present invention is a processing machine including at least one dolly on which a workpiece is loaded, and a robot that is loaded on the dolly and performs prescribed processing using a processing tool on the workpiece while the dolly is moving.

A second aspect of the present invention is a processing method including a step of loading a workpiece onto a dolly on which a robot for processing the workpiece is loaded, and a step of moving the dolly and performing prescribed processing, with the robot, on the workpiece loaded on the dolly while the dolly is moving.

According to the present invention, the prescribed processing can be performed on the workpiece while the dolly on which the workpiece is loaded is moving (while the workpiece is moving), and therefore it is possible to improve the processing productivity.

The above objects, features, and advantages will be easily understood from the following description of embodiments when taken in conjunction with the accompanying drawings.

### BRIEF DESCRIPTION OF DRAWINGS

FIG. 1 is a planar view showing an overall configuration of a processing machine according to the present embodiment;

FIG. 2 is a planar view of a state in which a vehicle floor that has yet to be respot welded has been loaded onto a first dolly of the processing machine;

FIG. 3 is a planar view of a state in which a vehicle floor that has yet to be respot welded has been loaded onto a second dolly of the processing machine;

FIG. 4 is a planar view of a state in which a vehicle floor that has yet to be respot welded has been loaded onto a third dolly of the processing machine;

FIG. 5 is a planar view of a state in which a vehicle floor that has yet to be respot welded has been loaded onto a fourth dolly of the processing machine;

FIG. 6 is a planar view of a state in which a respot-welded vehicle floor has been unloaded from the first dolly of the processing machine; and

FIG. 7 is a planar view of a state in which a respot-welded workpiece has been loaded onto the first dolly after a respot-welded vehicle floor has been unloaded from the first dolly of the processing machine.

### DESCRIPTION OF EMBODIMENTS

Preferred embodiments of a processing machine and processing method according to the present invention will be described in detail below, while referencing the accompanying drawings.

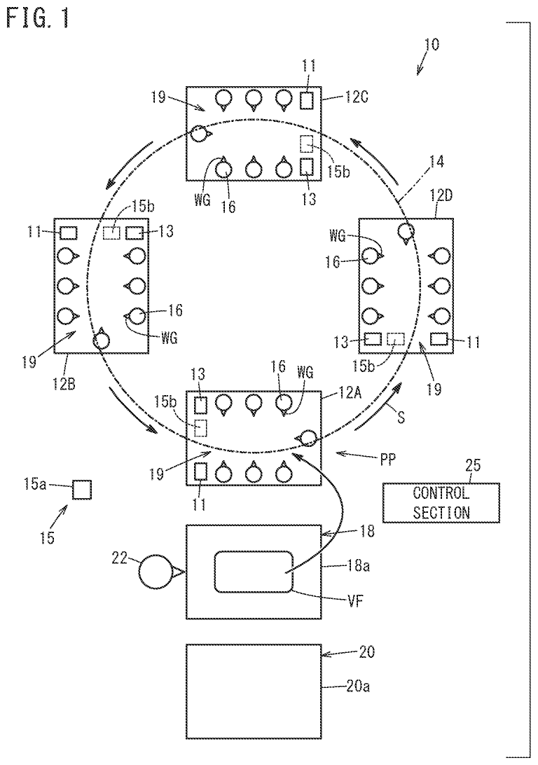

FIG. 1 is a planar view showing an example of a configuration of a processing machine 10. The processing machine 10 is installed on the floor of a factory (e.g., an automobile factory). The processing machine 10 is a machine that performs a welding process (specifically a respot welding process) on a vehicle floor VF, which is one example of a workpiece. As shown in FIG. 1, the processing machine 10 includes a plurality of (e.g., four) dollies 12 (a first dolly 12A, a second dolly 12B, a third dolly 12C, and a fourth dolly 12D) on which vehicle floors VF are loaded.

The workpiece that is the welding processing target of the processing machine 10 is not limited to being the vehicle floor VF, and may be a vehicle body or a metal structure other than a vehicle. The number of processing target workpieces loaded on each dolly 12 is not limited to being one, and may be greater than one. The processing performed by the processing machine 10 may be processing other than welding that uses a processing tool (e.g., processing such as polishing, cutting, pressing, painting, screwing, or assembling).

The four dollies 12 perform circulatory movement (circulation) along a prescribed circulation path 14. Each dolly 12 is an AGV (Automated Guided Vehicle), for example. Each dolly 12 includes a driving section 11 that operates using electric power. This driving section 11 is an electric motor, for example.

The method of the guiding the dollies 12 may be any method that can guide the dollies 12 so as not to deviate from the circulation path 14, and is electromagnetic guidance, optical guidance, magnetic guidance, image recognition guidance, independent guidance, or the like, for example.

The processing machine 10 further includes a storage battery 13 loaded on each dolly 12 that supplies power to a driving section 11 of the dolly 12, and also includes a charging system 15 that wirelessly charges the storage batteries 13. Here, the charging system 15 includes a power transmitting section 15a and power receiving sections 15b. The charging system 15 is also referred to as a non-contact power supply system.

The power transmitting section 15a includes a transmission coil that transmits electrical energy, and is installed on the floor outside the movement region of the plurality of dollies 12.

Each power receiving section 15b includes a reception coil that receives the transmitted electrical energy, and transmits the received electrical energy to the corresponding storage battery 13. A power receiving section 15b is provided to the bottom surface of each dolly 12. The power receiving section 15b provided to each dolly 12 receives the electrical energy from the power transmitting section 15a when facing and close to the power transmitting section 15a, and transmits this electrical energy to the storage battery 13 mounted in the dolly 12.

With the charging system 15 configured as described above, each dolly 12 moves to a location (on the floor) where the power transmitting section 15a is installed, and can wirelessly charge the storage battery 13 mounted on this dolly 12 by causing the power receiving section 15b mounted on this dolly 12 to be close to and face the power transmitting section 15a.

The charging system 15 is a short-range wireless charging system that performs charging by bringing the power transmitting section 15a and the power receiving section 15b close to each other as described above, but may instead be a long-range wireless charging system that transmits radio waves from the power transmitting section, receives these radio waves with the power receiving section, and converts these radio waves into power.

The circulation path 14 has a circular shape, as one example. The four dollies 12 are arranged on the circulation path 14 at uniform intervals along this circulation path 14 in an initial state, and move at a uniform speed in the same direction along the circulation path 14, which is a circulation direction of each dolly 12 (direction of the arrows S in FIG. 1) on the circulation path 14. That is, on the circular circulation path 14, each dolly 12 moves while maintaining a phase difference of 90° relative to the other dollies 17 adjacent thereto in the circulation path 14, and stops while maintaining this phase difference of 90°. Here, on the circulation path 14, the first dolly 12A, the second dolly 12B, the third dolly 12C, and the fourth dolly 12D are arranged in the stated order in a direction opposite to the circulation direction. The movement of each dolly 12 is controlled by a control section 25 included in the processing machine 10. Since each dolly 12 moves on the circular circulation path 14 (along the circumference), the movement amount of each dolly 12 on the circulation path 14 is expressed using a suitable angle (phase), as described above.

The size and shape of the circulation path 14 can be suitably changed. The shape of the circulation path 14 may be a shape other than a circle, such as an ellipse or polygon, for example, that allows for circulation (revolution). The number of dollies 12 can be suitably changed according to the size of each dolly 12, the size of the circulation path 14, the shape of the circulation path 14, and the like, for example.

The processing machine 10 further includes a plurality of (e.g., seven) robots 16 loaded on (installed on) each dolly 12. Each of these robots 16 performs respot welding (prescribed processing), using a welding gun WG as the processing tool, on the vehicle floor VF. Each of the robots 16 is a multi-jointed robot that includes a multi-jointed arm, for example, and has the welding gun WG attached to the tip of the multi-jointed arm. A plurality of robots 16 are arranged on each dolly 12 on which a vehicle floor VF is loaded, to be capable of welding different locations from each other on this vehicle floor VF. That is, these robots 16 are arranged around the perimeter of the region where the vehicle floor VF is loaded on the dolly 12 (also referred to below as a “VF loading region 19”).

The number of robots 16 loaded on each dolly 12 can be suitably changed according to the number of locations on the vehicle floor VF to be welded or the like, for example.

Each of the robots 16 loaded on each dolly 12 performs respot welding on the vehicle floor VF while the dollies 12 are moving. Specifically, the plurality of robots 16 loaded on each dolly 12 complete the respot welding on the vehicle floor VF while the dolly 12 circulates through (revolves along) the circulation path 14 N times (N here is one). That is, a required time T needed for the respot welding is substantially the same among the vehicle floors VF, and the movement velocity and stop time of each dolly 12 is set such that the time for each dolly 12 to perform one revolution on the circulation path 14 is greater than or equal to the required time T (preferably close to the required time T). Here, each robot 16 automatically performs the respot welding using the welding gun WG, in accordance with a control program for the respot welding of the vehicle floor VF. The N revolutions described above may be a plurality of revolutions.

The processing machine 10 further includes a workpiece loading station 18 that loads the vehicle floors VF that have yet to be respot-welded to the dollies 12 arranged on the circulation path 14. A vehicle floor VF that has yet to be respot-welded refers to a vehicle floor VF that has been tentatively welded to a degree at which the plurality of configurational elements forming the vehicle floor VF are kept in the overall shape of the vehicle floor VF. Here, the workpiece loading station 18 loads a vehicle floor VF that has yet to be respot-welded onto the dolly 12 positioned at a prescribed position PP on the circulation path 14.

The workpiece loading station 18 is arranged at a position adjacent to the prescribed position PP on the circulation path 14. The workpiece loading station 18 includes a base portion 18a on which the vehicle floor VF that has been tentatively welded (before the respot welding) is loaded. The workpiece loading station 18 includes a loading/unloading robot 22 that lifts up the vehicle floor VF loaded on the base portion 18a and moves (loads) the vehicle floor VF onto the dolly 12 positioned at the prescribed position PP.

The tentatively welded vehicle floor VF is carried to the base portion 18a from a lane where the tentative welding is performed, by a transport robot (not shown in the drawings), for example.

The processing machine 10 further includes a workpiece unloading station 20 that unloads the respot-welded vehicle floor VF from the dolly 12 positioned on the circulation path 14. Here, the workpiece unloading station 20 unloads the respot-welded vehicle floor VF from the dolly 12 positioned at the prescribed position PP on the circulation path 14.

The position of the dolly 12 on the circulation path 14 when the vehicle floor VF is being loaded (also referred to below as a “first position”) and the position of the dolly 12 on the circulation path 14 when the vehicle floor VF is being unloaded (also referred to below as a “second position”) may be different from each other. For example, the first position and the second position may be shifted by 90° or 180° relative to each other on the circulation path 14.

The workpiece unloading station 20 is arranged at a position adjacent to the workpiece loading station 18, on the side of the workpiece loading station 18 opposite to the circulation path 14. The positional relationship between the workpiece unloading station 20 and the workpiece loading station 18 may be reversed. The workpiece unloading station 20 includes a base portion 20a on which the respot-welded vehicle floor VF is placed. The workpiece unloading station 20 further includes a loading/unloading robot 22 that picks up the respot-welded vehicle floor VF from the dolly 12 positioned at the prescribed position PP, and moves (unloads) this vehicle floor VF onto the base portion 20a. Specifically, the workpiece loading station 18 and the workpiece unloading station 20 share the loading/unloading robot 22. Instead, the workpiece loading station 18 may have a robot specialized for loading and the workpiece unloading station 20 may have a robot specialized for unloading.

The respot-welded vehicle floor VF unloaded onto the base portion 20a is carried by a transport robot (not shown in the drawings), for example, to a lane where the next processing is to be performed.

As understood from the above description, the prescribed position PP is a position where the vehicle floor VF is loaded onto and unloaded from each dolly 12, and therefore may be referred to as a “loading/unloading position”.

The following describes the operation of the processing machine 10 configured in the manner described above.

In the initial state, as shown in FIG. 1, the first dolly 12A, which does not have a vehicle floor VF loaded thereon, is stopped at the prescribed position PP. The second dolly 12B, which does not have a vehicle floor VF loaded thereon, is stopped at a position 90° upstream in the circulation direction from the first dolly 12A. The third dolly 12C, which does not have a vehicle floor VF loaded thereon, is stopped at a position 90° upstream in the circulation direction from the second dolly 12B. The fourth dolly 12D, which does not have a vehicle floor VF loaded thereon, is stopped at a position 90° upstream in the circulation direction from the third dolly 12C.

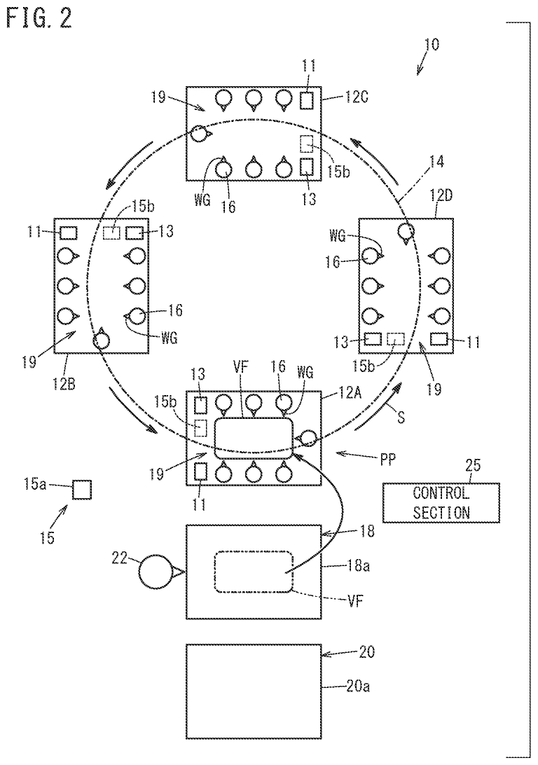

First, as shown in FIG. 2, the processing machine 10 uses the workpiece loading station 18 to load a vehicle floor VF onto the VF loading region 19 (see FIG. 1) of the first dolly 12A that has a plurality of (e.g., seven) robots 16 loaded thereon. Specifically, using the loading/unloading robot 22, the processing machine 10 lifts up the vehicle floor VF on the base portion 18a and moves (loads) this vehicle floor VF onto the VF loading region 19 of the first dolly 12A.

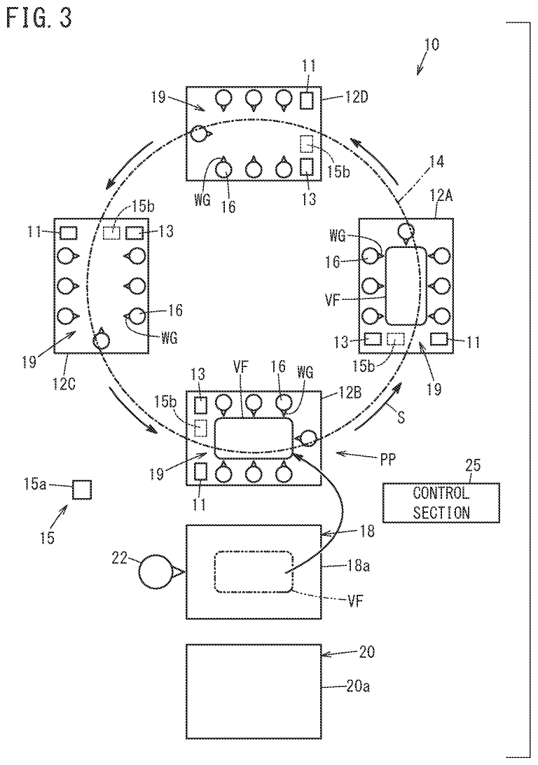

Next, the processing machine 10 starts circulating each dolly 12 on the circulation path 14, and causes the plurality of robots 16 on the first dolly 12A to start the respot welding of the vehicle floor VF. That is, the processing machine 10 performs respot welding with the plurality of robots 16 on the vehicle floor VF loaded on the first dolly 12A, while causing the first dolly 12A having the vehicle floor VF loaded thereon and the second dolly 12B, the third dolly 12C, and the fourth dolly 12D that do not have vehicle floors VF loaded thereon to circulate. Then, as shown in FIG. 3, when the phase of each dolly 12 has progressed by 90°, that is, when the second dolly 12B has reached the prescribed position PP, the processing machine 10 uses the workpiece loading station 18 to load a vehicle floor VF onto the VF loading region 19 of the second dolly 12B that has a plurality of (e.g., seven) robots 16 loaded thereon. During the work of loading the vehicle floor VF onto the second dolly 12B as well, each dolly 12 continues moving (circulating) with a constant velocity, and the respot welding is performed on the vehicle floor VF of the moving first dolly 12A.

When each dolly 12 has progressed 90° from the positions shown in FIG. 2 to the positions shown in FIG. 3, that is, when the second dolly 12B has moved to the prescribed position PP, the processing machine 10 may stop the circulation of each dolly 12. In such a case, the processing machine 10 uses the workpiece loading station 18 to load a vehicle floor VF onto the VF loading region 19 of the stopped second dolly 12B. Even when the first dolly 12A is stopped, the respot welding by the plurality of robots 16 on the first dolly 12A continues. In the following description, the circulation of each dolly 12 may be stopped when each of the second to fourth dollies 12B to 12C is moved to the prescribed position PP, in the same manner as the first dolly 12A.

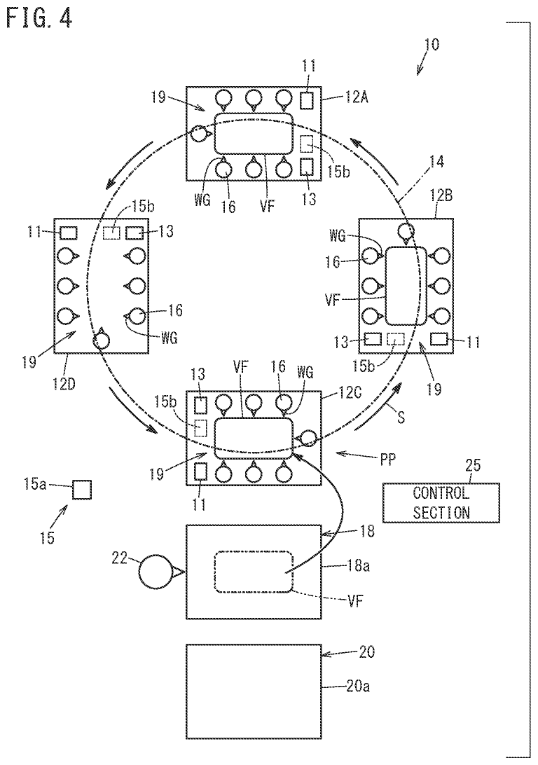

Next, the processing machine 10 restarts the circulation of each dolly 12 on the circulation path 14, and causes the plurality of robots 16 on the second dolly 12B to start the respot welding of the vehicle floor VF. That is, the processing machine 10 performs respot welding with the plurality of robots 16 on the vehicle floors VF loaded respectively on the first dolly 12A and the second dolly 12B, while causing the first dolly 12A and second dolly 12B having the vehicle floors VF loaded thereon and the third dolly 12C and fourth dolly 12D that do not have vehicle floors VF loaded thereon to circulate. Then, as shown in FIG. 4, when the phase of each dolly 12 has progressed by 90°, that is, when the third dolly 12C has reached the prescribed position PP, the processing machine 10 uses the workpiece loading station 18 to load a vehicle floor VF onto the VF loading region 19 of the third dolly 12C that has a plurality of (e.g., seven) robots 16 loaded thereon. During the work of loading the vehicle floor VF onto the third dolly 12C as well, each dolly 12 continues moving (circulating) with a constant velocity, and the respot welding is performed on the vehicle floors VF of the moving first dolly 12A and second dolly 12B.

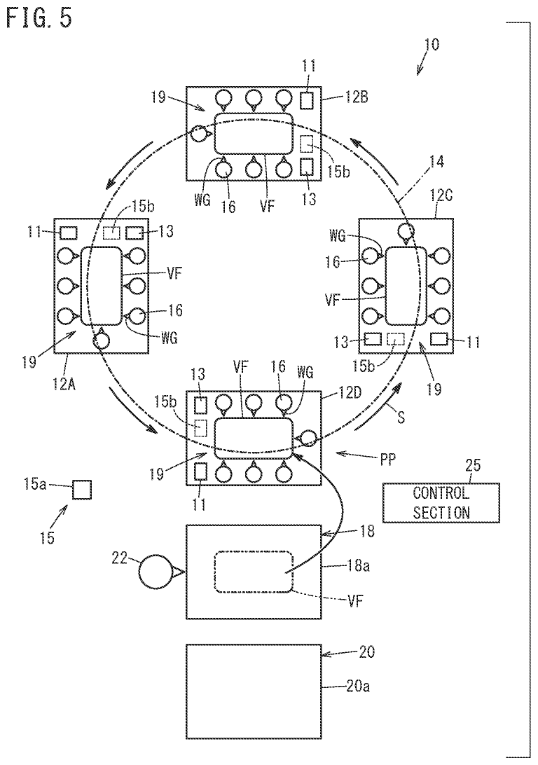

Next, the processing machine 10 restarts the circulation of each dolly 12 on the circulation path 14, and causes the plurality of robots 16 on the third dolly 12C to start the respot welding of the vehicle floor VF. That is, the processing machine 10 performs respot welding with the plurality of robots 16 on the vehicle floors VF loaded respectively on the first dolly 12A, the second dolly 12B, and the third dolly 12C, while causing the first dolly 12A, the second dolly 12B, and the third dolly 12C having the vehicle floors VF loaded thereon and the fourth dolly 12D that does not have a vehicle floor VF loaded thereon to circulate. Then, as shown in FIG. 5, when the phase of each dolly 12 has progressed by 90°, that is, when the fourth dolly 12D has reached the prescribed position PP, the processing machine 10 uses the workpiece loading station 18 to load a vehicle floor VF onto the VF loading region 19 of the fourth dolly 12D that has a plurality of (e.g., seven) robots 16 loaded thereon. During the work of loading the vehicle floor VF onto the fourth dolly 12D as well, each dolly 12 continues moving (circulating) with a constant velocity, and the respot welding is performed on the vehicle floors VF of the moving first dolly 12A, second dolly 12B, and third dolly 12C. The circulation of each dolly 12 is stopped. Even when stopped, the respot welding by the plurality of robots 16 continues to be performed on each of the first dolly 12A, the second dolly 12B, and the third dolly 12C.

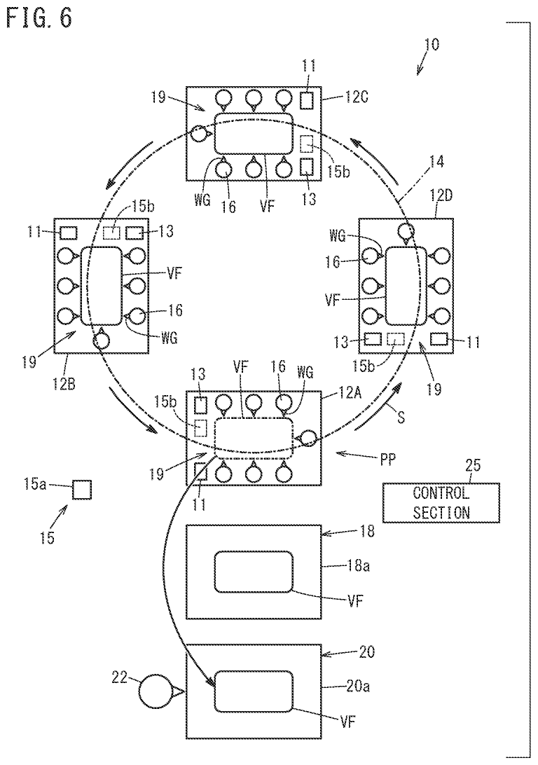

Next, the processing machine 10 restarts the circulation of each dolly 12 on the circulation path 14, and causes the plurality of robots 16 on the fourth dolly 12D to start the respot welding of the vehicle floor VF. That is, the processing machine 10 performs respot welding with the plurality of robots 16 on the vehicle floors VF loaded respectively on the first dolly 12A, the second dolly 12B, the third dolly 12C, and the fourth dolly 12D, while causing the first dolly 12A, the second dolly 12B, the third dolly 12C, and the fourth dolly 12D having the vehicle floors VF loaded thereon to circulate. Then, when the phase of each dolly 12 has progressed by 90°, that is, when the first dolly 12A has reached the prescribed position PP, the processing machine 10 uses the workpiece unloading station 20 to unload (recover) the respot-welded vehicle floor VF from the first dolly 12A as shown in FIG. 6. That is, using the loading/unloading robot 22, the processing machine 10 lifts up the respot-welded vehicle floor VF positioned on the VF loading region 19 of the first dolly 12A and moves (unloads) this vehicle floor VF onto the base portion 20a. The respot-welded vehicle floor VF unloaded onto the base portion 20a is carried from the base portion 20a to a lane where the next processing is to be performed. During the work of recovering the vehicle floor VF from the first dolly 12A as well, each dolly 12 continues moving (circulating) at a constant velocity, and the respot welding is performed on the vehicle floor VFS on the moving second dolly 12B, third dolly 12C, and fourth dolly 12D.

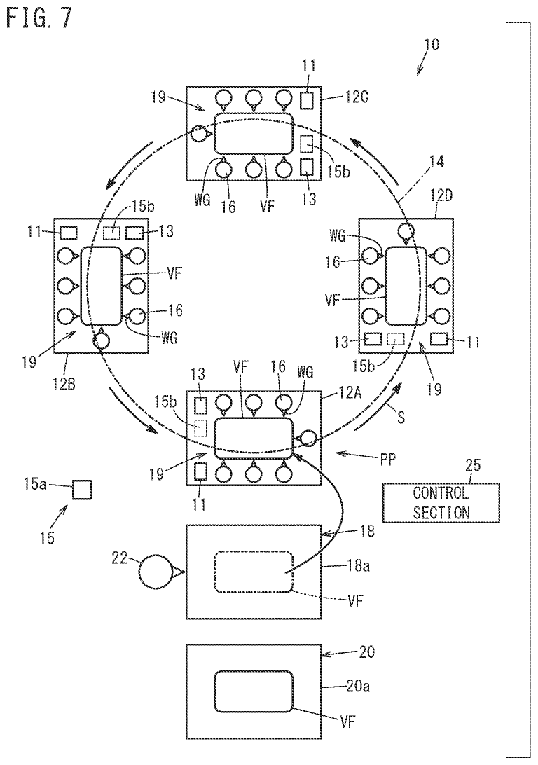

Next, as shown in FIG. 7, the processing machine 10 uses the workpiece loading station 18 to load a tentatively welded (before respot welding) vehicle floor VF onto the moving first dolly 12A. That is, using the loading/unloading robot 22, the processing machine 10 lifts up the tentatively welded vehicle floor VF that is on the base portion 18a, and moves (loads) this vehicle floor VF onto the VF loading region 19 of the first dolly 12A. During the work of loading the vehicle floor VF onto the first dolly 12A as well, the respot welding is performed on the vehicle floors VF that are on the second dolly 12B, the third dolly 12C, and the fourth dolly 12D. A new tentatively welded vehicle floor VF is carried onto the base portion 18a from which the previous tentatively welded vehicle floor VF has been removed.

In this way, for the first dolly 12A moving at the prescribed position PP, the processing machine 10 performs the unloading (recovery) of the respot-welded vehicle floor VF and the loading of the tentatively welded vehicle floor VF in series.

After this, every time each dolly 12 progress by 90° on the circulation path 14, the processing machine 10 performs the unloading (recovery) of the respot-welded vehicle floor VF and the loading of the tentatively-welded vehicle floor VF in series for the dolly 12 moving at the prescribed position PP, in the same manner as described above.

With the operation of the processing machine 10 described above, during the work of loading a vehicle floor VF onto a dolly 12 and the work of recovering a workpiece from a dolly 12, the respot welding is performed on the vehicle floors VF of the other dollies 12, but the operation of the processing machine 10 is not limited to this. For example, the respot welding may be performed on the vehicle floors VF of the other dollies 12 during only one of the loading work and the recovery work, and it is also acceptable for the respot welding to not be performed on the vehicle floors VF of the other dollies 12 during both the loading work and the recovery work.

The following describes the advantageous effects of the processing machine 10 configured in the manner described above and the processing method using this processing machine 10.

The processing machine 10 of the present embodiment comprises at least one dolly 12 on which the vehicle floor VF (workpiece) is loaded, and the robot 16 that is loaded on the dolly 12 and performs respot welding (prescribed processing) on the vehicle floor VF, using a welding gun WG (processing tool), while the dolly 12 is moving.

Due to this, it is possible to perform respot welding on the vehicle floor VF while the dolly 12 having the vehicle floor VF loaded thereon is moving (while the workpiece is moving), and therefore it is possible to improve the processing productivity.

The at least one dolly 12 is the plurality of dollies 12. Due to this, it is possible to perform the respot welding in parallel on the vehicle floor VF on each of the plurality of dollies 12. In other words, it is possible to perform the respot welding in parallel on each of a plurality of vehicle floors VF. As a result, the processing productivity can be improved.

The plurality of dollies 12 circulate along the prescribed circulation path 14, and the robots 16 loaded respectively on the plurality of dollies 12 perform the respot welding while the dollies 12 are circulating along the circulation path 14. Due to this, the plurality pf dollies 12 can move efficiently. Furthermore, by setting the circulation velocity to be low, it is possible to shorten the circulation path and reduce the installation area.

The processing machine 10 further includes the workpiece loading station 18 that loads a vehicle floor VF that has yet to be respot-welded onto the dolly 12 positioned on the circulation path 14; and the workpiece unloading station 20 that unloads the respot-welded vehicle floor VF from the dolly 12 positioned on the circulation path 14. Due to this, the workpiece can be directly loaded onto and unloaded from the dolly 12 positioned on the circulation path 14, and therefore it is possible to improve the processing productivity without affecting the circulating transport of the dollies 12.

The workpiece loading station 18 loads the vehicle floor VF that has yet to be respot-welded onto the dolly 12 positioned at the prescribed position PP on the circulation path 14, and the workpiece unloading station 20 unloads the respot-welded vehicle floor VF from the dolly 12 positioned at the prescribed position PP on the circulation path 14. Due to this, the recovery of the respot-welded vehicle floor VF and the loading of the VF that has yet to be respot-welded can be performed in series for each dolly 12 positioned at the prescribed position PP on the circulation path 14, and therefore it is possible to improve the processing productivity.

The plurality of the robots 16 are provided on each of the plurality of dollies 12. Due to this, respot welding can be performed temporally in parallel on a plurality of locations on the vehicle floor VF by the plurality of robots 16 on a dolly 12, and therefore it is possible to improve the processing productivity.

The prescribed processing is welding, and the processing tool is a welding gun. Since the welding work does not require as much spot position accuracy as fastening work, it is possible to perform the welding smoothly during the circulatory transport work.

The vehicle floor VF is loaded onto the dolly 12 and undergoes the respot welding after undergoing tentative welding. Due to this, the respot welding can be performed in a state where the overall shape of the vehicle floor VF is maintained, i.e., a state in which configurational components of the vehicle floor VF to be welded are tentatively fixed to each other, and therefore there is no need to hold the configurational components of the vehicle floor VF to be welded in a weldable manner. In other words, since the respot welding is performed on the vehicle floor VF for which the tentative fixing has been completed, it is possible to significantly reduce the number of vehicle floor fixing jigs, and to improve workability by reducing the weight of the dollies and reducing interfering objects.

The dolly 12 includes the driving section 11 that operates using electrical power, and the processing machine 10 further includes the storage battery 13 that is loaded on the dolly 12 and supplies the electrical power to the driving section 11, and the charging system 15 that wirelessly charges the storage battery 13. Due to this, it is possible to charge the storage battery 13 loaded on the dolly 12 without using a charging cable or the like.

The processing method according to the present embodiment includes a step of loading the vehicle floor VF on the dolly 12 on which the robot 16 for processing the vehicle floor VF (processing a workpiece) is loaded, and a step of moving the dolly 12 and respot welding, with the robot 16, on the vehicle floor VF loaded on the dolly 12, while the dolly 12 is moving.

Due to this, the respot welding can be performed on the vehicle floor VF while the dolly 12 on which the vehicle floor VF is loaded is moving (while the workpiece is moving), and therefore it is possible to improve the processing productivity.

The processing method of the present embodiment further comprises a step of recovering the respot-welded vehicle floor VF from the dolly 12. Due to this, it is possible to load another vehicle floor VF that has yet to be respot-welded onto the dolly 12 from which the respot-welded vehicle floor VF has been recovered.

In the step of loading the vehicle floor VF, the vehicle floor VF is loaded onto the dolly 12 when the dolly 12 is positioned on the circulation path 14; in the step of moving the dolly 12, the dolly 12 circulates along the circulation path 14; and in the step of recovering the vehicle floor VF, the respot-welded vehicle floor VF is recovered from the dolly 12 when the dolly 12 is positioned on the circulation path 14. Due to this, the dolly 12 can move efficiently and the vehicle floor VF can be loaded onto and unloaded from the dolly 12 positioned on the circulation path 14 directly, and therefore it is possible to improve the processing productivity.

In the step of loading the vehicle floor VF, the vehicle floor VF is loaded onto the dolly 12 when the dolly 12 is positioned at a prescribed position PP on the circulation path 14; and in the step of recovering the vehicle floor VF, the respot-welded vehicle floor VF is recovered from the dolly 12 when the dolly 12 is positioned at the prescribed position PP on the circulation path 14. Due to this, the recovery of the respot-welded vehicle floor VF and the loading of the VF that has yet to be respot-welded can be performed in series for the dolly 12 positioned at the prescribed position PP on the circulation path 14, and therefore it is possible to improve the processing productivity.

In the processing method of the present embodiment, during at least one of work of loading the vehicle floor VF onto the dolly 12 or work of recovering the workpiece from the dolly 12, the respot welding is performed on the vehicle floor VF on another dolly 12. Due to this, it is possible to improve the processing productivity. That is, the welding work can continue on dollies 12 for which the workpiece does not need to be transferred, and it is possible to effectively utilize the man-hours for the work without interrupting the work.

### [Modifications]

The configuration of the processing machine 10 according to the embodiment described above can be suitably altered.

In the embodiment described above, the processing machine 10 includes a plurality of dollies 12, but the processing machine 10 may instead include a single dolly 12. In such a case, the circulation path 14 is not necessary.

In the embodiment described above, the plurality of dollies 12 circulate along the circulation path 14, but the present invention is not limited to this. For example, at least one dolly 12 may move back and forth on a prescribed path that is not circulatory. In such a case, the workpiece loading station 18 and the workpiece unloading station 20 may be installed at one end of the path, and the loading and unloading of the vehicle floors VF onto and from the dollies 12 may be performed at the one end of the path. Alternatively, the workpiece loading station 18 may be installed at one end of the path, the workpiece unloading station 20 may be installed at the other end of the path, the loading of the vehicle floors VF onto the dollies 12 may be performed at the one end of the path, and the unloading of the vehicle floors VF from the dollies 12 may be performed at the other end of the path.

In the embodiment described above, the processing machine 10 stops a dolly 12 at the prescribed position PP on the circulation path 14 and loads and unloads the vehicle floors VF onto and from this dolly 12, but the present invention is not limited to this. For example, the processing machine 10 may load and unload the vehicle floors VF onto and from the dolly 12 while the dolly 12 is moving along the circulation path 14. Specifically, the processing machine 10 may load and unload the vehicle floors VF onto and from the dolly 12 when the dolly 12 approaches the prescribed position PP. However, in such a case, it is necessary to operate the loading/unloading robot 22 in synchronization with the movement of the dolly 12.

What is claim is:

1. A processing machine comprising:
at least one dolly on which a workpiece is loaded; and
a robot that is loaded on the dolly and performs prescribed processing using a processing tool on the workpiece while the dolly is moving.

2. The processing machine according to claim 1, wherein the at least one dolly is a plurality of dollies.

3. The processing machine according to claim 2, wherein the plurality of dollies circulate along a prescribed circulation path, and
the robots loaded respectively on the plurality of dollies perform the prescribed processing while the dollies are circulating along the circulation path.

4. The processing machine according to claim 3, further comprising:
a workpiece loading station that loads a workpiece that has yet to undergo the prescribed processing onto the dolly positioned on the circulation path; and
a workpiece unloading station that unloads the workpiece that has undergone the prescribed processing from the dolly positioned on the circulation path.

5. The processing machine according to claim 4, wherein the workpiece loading station loads the workpiece that has yet to undergo the prescribed processing onto the dolly positioned at a prescribed position on the circulation path, and
the workpiece unloading station unloads the workpiece that has undergone the prescribed processing from the dolly positioned at the prescribed position on the circulation path.

6. The processing machine according to claim 2, wherein a plurality of the robots are provided on each of the plurality of dollies.

7. The processing machine according to claim 1, wherein the prescribed processing is welding, and
the processing tool is a welding gun.

8. The processing machine according to claim 7, wherein the workpiece is loaded onto the dolly and undergoes the prescribed processing after undergoing tentative welding, and
the prescribed processing is respot welding.

9. The processing machine according to claim 1, wherein the dolly includes a driving section that operates using electrical power, and
the processing machine further comprises:
a storage battery that is loaded on the dolly and supplies electrical power to the driving section; and
a charging system that wirelessly charges the storage battery.

10. A processing method comprising:
a step of loading a workpiece onto a dolly on which a robot for processing the workpiece is loaded; and
a step of moving the dolly and performing prescribed processing, with the robot, on the workpiece loaded on the dolly while the dolly is moving.

11. The processing method according to claim 10, further comprising a step of recovering the workpiece that has undergone the prescribed processing from the dolly.

12. The processing method according to claim 11, wherein in the workpiece loading step, the workpiece is loaded onto the dolly when the dolly is positioned on the circulation path,
in the dolly moving step, the dolly circulates along the circulation path, and
in the workpiece recovering step, the workpiece that has undergone the prescribed processing is recovered from the dolly when the dolly is positioned on the circulation path.

13. The processing method according to claim 12, wherein in the workpiece loading step, the workpiece is loaded onto the dolly when the dolly is positioned at a prescribed position on the circulation path, and
in the workpiece recovering step, the workpiece that has undergone the prescribed processing is recovered from the dolly when the dolly is positioned at the prescribed position on the circulation path.

14. The processing method according to claim 12, wherein during at least one of work of loading the workpiece onto the dolly or work of recovering the workpiece from the dolly, the prescribed processing is performed on the workpiece on another dolly.
